(19) United States
(12) Patent Application Publication
(10) Pub. No.: US 2020/0135394 A1
(43) Pub. Date: Apr. 30, 2020

(54) Electromagnetic coil dispenser for improving waterproof performance

(71) Applicant: Juanying Tong, Taizhou City (CN)

(72) Inventor: Juanying Tong, Taizhou City (CN)

(21) Appl. No.: 16/726,956

(22) Filed: Dec. 26, 2019

(30) Foreign Application Priority Data
Sep. 19, 2019 (CN) 2019108858085

(51) Int. Cl. H01F 41/096

(52) U.S. Cl. CPC H01F 41/096

(57) ABSTRACT

The present invention discloses a method for improving the solenoid dispensing water resistance, comprising a base, said base top surface of the fixed mounting support column slidably mounted threaded rod of the boom, the bottom of the threaded rod fixedly mounted may coil for dispensing of the dispensing head, when the dispensing start lifting the motor, the lifting motor drives a first gear, a first gear rotatably drives the second gear, the second gear rotates the threaded rod may be down to the coil dispensing improved dispensing manner, increasing the efficiency of dispensing can be generated after a significant reduction dispensing bubbles, to improve the quality of the coil, glue extrusion by pressurizing the way, bubbles in the glue are deposited After the dispensing is completed, use the vibration method to shake the air bubbles in the coil to make the coil have better quality.

### CROSS-REFERENCES TO RELATED APPLICATIONS

The present application claims priority from Chinese application No. 2019108858085 filed on Sep. 19, 2019 which is hereby incorporated by reference in its entirety.

### TECHNICAL FIELD

The invention relates to the field of electrical products, in particular to an electromagnetic coil dispenser for improving waterproof performance.

### BACKGROUND OF THE INVENTION

In the manufacture of some household appliances, a large number of coils are used, and in order to prevent leakage of electricity due to water ingress when the coils are manufactured, generally the glue is sealed when the coils are finally formed.

Generally, coils are dispensed using manual dispensing methods. Compared to dispensing equipment, this can ensure that a large number of air bubbles are not generated in the glue. Current dispensing equipment cannot take into account efficiency and dispensing. Quality, especially when dispensing, there will be a large number of air bubbles, which will easily cause the coil to leak water. At the same time, when the glue is stored in the container, there will also be a large number of air bubbles. If the air bubbles are not removed, it will also affect the coil. quality.

### BRIEF SUMMARY OF THE INVENTION

An object of the present invention is to provide an electromagnetic coil dispenser for improving waterproof performance, which is used to overcome the above-mentioned defects in the prior art.

An electromagnetic coil dispenser for improving waterproof performance according to an embodiment of the present invention includes a base, and a support post is fixedly installed on the top surface of the base, and the support post is provided with an outlet for dispensing the coil. A glue mechanism, the glue dispensing mechanism comprises a cantilever fixedly installed on the left side of the support column, a threaded rod is slidably installed on the cantilever, and a glue dispensing head capable of dispensing coils is fixedly installed at the bottom of the threaded rod, A storage box is fixedly installed on the right side of the support column, and a storage cavity is provided in the storage box. The storage cavity is filled with glue for dispensing. An air pump is fixedly installed on the top surface of the support column. The storage cavity can be inflated and pressurized, so that the glue in the storage cavity can be squeezed out through the dispensing head,

A rotation platform is rotatably installed on the top surface of the base, and the rotation platform is provided with a clamping mechanism capable of clamping a coil. The clamping mechanism includes a rotation space provided on the top surface of the rotation platform. An eccentric wheel space with an upward opening is provided on the rotating platform. An eccentric wheel shaft is rotatably installed between the eccentric wheel space and an inner wall on one side of the rotating space. The eccentric wheel shaft is fixedly mounted with the eccentric wheel. The coil fixing seat is provided with a coil clamping space capable of clamping the coil. When the eccentric rotates, the coil fixing seat will be driven to vibrate up and down, so that the glue on the coil in the coil clamping space is contained in the coil. The bubbles can be removed.

Based on the above technical solution, the glue dispensing mechanism further includes a gear cavity provided in the cantilever, a lifting motor is fixedly installed in the bottom wall of the gear cavity, and a first gear is fixedly installed on the output shaft of the lifting motor. A second gear is rotatably installed between the upper and lower inner walls of the gear cavity, and the second gear is threadedly installed with the threaded rod.

Based on the above technical solution, a connecting base is fixedly installed on the bottom surface of the cantilever, and a turntable is rotatably installed on the connecting base. A torsion spring is provided between the turntable and the connecting base, and the right side of the turntable is fixed. A mounting platform is installed, a fixing pin is fixedly installed on the rear side of the torsion spring, a connecting rod is fixedly installed on the threaded rod, and an inclined block is fixedly installed on the connecting rod, and the inclined block is slidably installed with the fixed pin.

Based on the above technical solution, an air outlet pipe is connected to the air outlet of the air pump, and the air outlet pipe is in communication with the storage cavity.

On the basis of the above technical solution, a communication inlet is provided between the top wall of the storage chamber and the top surface of the storage box, a scale is provided on the right side of the storage box, and a bottom wall of the storage chamber is provided. A glue outlet pipe is provided, the glue outlet pipe runs through the support column, the dispensing head communicates with a fixed installation joint, the joint communicates with the support column, and a control valve is fixedly installed in the glue outlet pipe.

Based on the above technical solution, the clamping mechanism further includes a vibration motor fixedly installed in the base, a first bevel gear is fixedly mounted on the output shaft of the vibration motor, and a second bevel gear is fixedly mounted on the eccentric shaft. The second bevel gear meshes with the first bevel gear.

Based on the above technical solution, the coil fixing seat is slidably connected to an eccentric wheel, and a pulling spring is fixedly installed between the bottom surface of the eccentric wheel and the bottom wall of the eccentric wheel space.

Based on the above technical solution, a clamping plate is hingedly installed on the coil fixing base, a fixing rod is hingedly installed on the clamping plate, a fixing buckle is fixedly installed on the coil fixing base, and the fixing rod and the fixing buckle can be hooked to each other, The coil is clamped, and the rope is fixedly connected between the coil clamping space and the rope.

On the basis of the above technical solution, a gear is provided on an inner wall of the rotation space, a rotation motor is fixedly installed in the base, a third gear is fixedly installed on the output shaft of the rotation motor, and the third gear is connected to the rotation space. Gears on the inner wall mesh.

The beneficial effects of the present invention are: the method for improving the dispensing of the present invention does not require manual dispensing, increases the efficiency of dispensing, can also significantly reduce air bubbles generated after dispensing, and improves the quality of the coil,

The glue is squeezed out by means of pressure. When the glue is in the storage chamber, the pressure of the glue should increase. The bubbles in the glue will be precipitated. After the dispensing is completed, use the vibration method to shake the bubbles in the coil. Come out, so that the coil has better quality and is worth promoting.

### BRIEF DESCRIPTION OF THE DRAWINGS

In order to more clearly explain the embodiments of the present invention or the technical solutions in the prior art, the drawings used in the embodiments will be briefly introduced below. Obviously, the drawings in the following description are only some of the invention For those of ordinary skill in the art, other embodiments may be obtained based on these drawings without paying creative effort.

FIG. 1 is a schematic diagram of the overall structure of the present invention;

FIG. 2 is a schematic cross-sectional structure view taken along the direction A-A in FIG. 1;

FIG. 3 is a schematic cross-sectional structure view taken along the B-B direction in FIG. 1;

FIG. 4 is a schematic structural diagram of a direction C in FIG. 3.

### DETAILED DESCRIPTION OF THE INVENTION

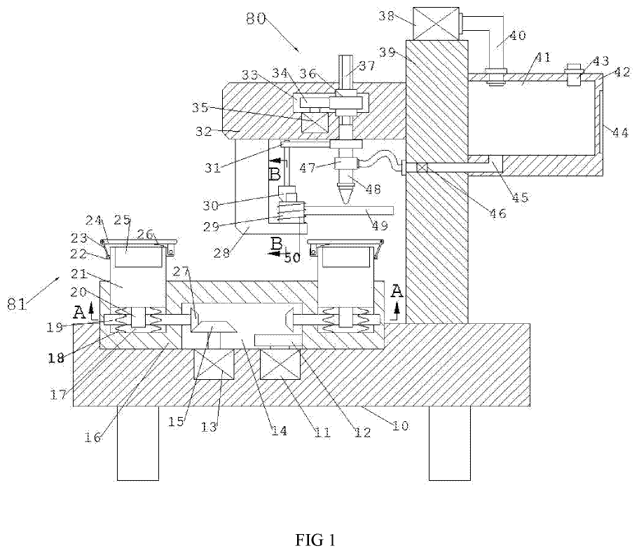

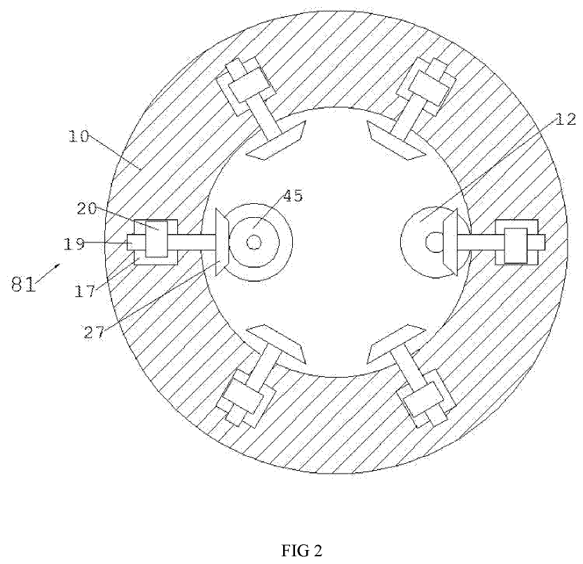

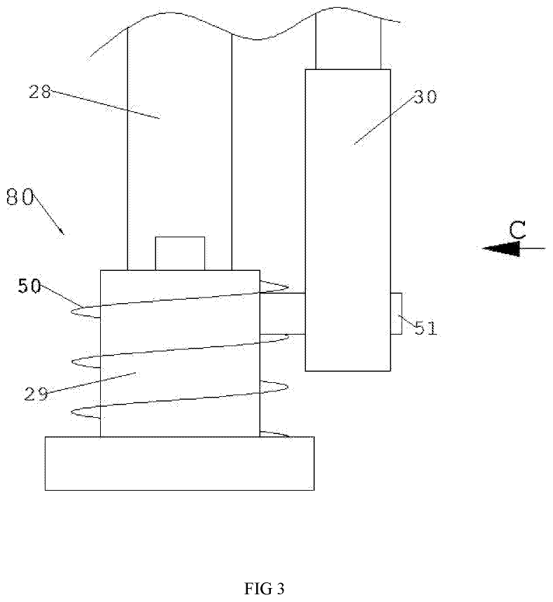

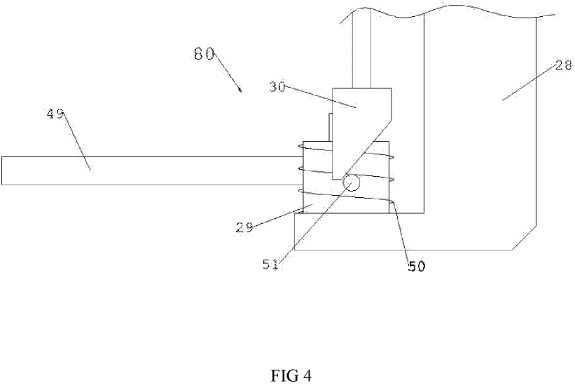

The present invention will be described in detail below with reference to FIGS. 1-4. Among them, for convenience of description, the orientation described below is defined as follows: the up-down, left-right, front-back, and up-down directions described below are consistent with the front-back, left-right, up-down, and down directions of the view direction of FIG. 1 is a front view of the device of the present invention, and the direction shown in FIG. 1 is the same as the front, rear, left, right, and up and down directions of the device of the present invention.

1-4, an electromagnetic coil dispenser for improving waterproof performance according to an embodiment of the present invention includes a base 10, and a support post 39 is fixedly mounted on the top surface of the base 10, and the support post 39 is mounted on the support post 39. A glue dispensing mechanism 80 capable of dispensing coils is provided. The glue dispensing mechanism 80 includes a cantilever 32 fixedly installed on the left side of the support column 39, and a threaded rod 37 is slidably mounted on the cantilever 32. The bottom of the threaded rod 37 is fixedly installed with a dispensing head 48 capable of dispensing coils. A storage box 42 is fixedly installed on the right side of the support column 39, and a storage cavity 41 is provided in the storage box 42. Dispensing glue is installed in the cavity 41. An air pump 38 is fixedly installed on the top surface of the support column 39. The air pump 38 can inflate and pressurize the storage cavity 41, so that the glue in the storage cavity 41 passes the dispensing head 48. Squeeze out,

A rotation platform 16 is rotatably mounted on the top surface of the base 10. A clamping mechanism 81 capable of clamping a coil is provided on the rotation platform 16. The clamping mechanism 81 includes a top surface of the rotation platform 16. The rotating platform 14 is provided with an eccentric wheel space 17 with an upward opening on the rotating platform 16. An eccentric wheel shaft 19 is rotatably installed between the eccentric wheel space 17 and an inner wall on one side of the rotating space 14. An eccentric wheel 20 is fixedly installed, and a coil fixing seat 21 is slidably installed in the eccentric wheel space 17. The coil fixing seat 21 is provided with a coil clamping space 25 for clamping the coil. When the eccentric wheel 20 rotates, it will The coil fixing base 21 is driven to vibrate up and down, so that the air bubbles in the glue on the coil on the coil clamping space 25 can be removed.

In addition, in an embodiment, the glue dispensing mechanism 80 further includes a gear cavity 33 provided in the cantilever 32, a lifting motor 35 is fixedly installed in the bottom wall of the gear cavity 33, and the output shaft of the lifting motor 35 is fixed on the output shaft. A first gear 34 is fixedly installed, and a second gear 36 is rotatably installed between the upper and lower inner walls of the gear cavity 33. The second gear 36 is threadedly installed with the threaded rod 37. When dispensing, the lift motor 35 is started to lift The motor 35 drives the first gear 34 to rotate, the first gear 34 rotates to drive the second gear 36, and the second gear 36 rotates to the threaded rod 37 to dispense the coil downward.

A connection base 28 is fixedly installed on the bottom surface of the cantilever 32, and a turntable 29 is rotatably installed on the connection base 28. A torsion spring 50 is provided between the turntable 29 and the connection base 28, and a right side surface of the turntable 29 The receiving platform 49 is fixedly installed, the fixing pin 51 is fixedly installed on the rear side of the torsion spring 50, the connecting rod 31 is fixedly installed on the threaded rod 37, and the inclined block 30 is fixedly installed on the connecting rod 31. 30 and the fixed pin 51 are slidingly installed. During the dispensing, the threaded rod 37 drives the connecting rod 31 and the inclined block 30 to slide downwards, so that the fixed pin 51 drives the torsion spring 50 and the receiving platform 49 to rotate backward, and The table 49 will not block the dispensing head 48 after rotating backward, which is convenient for dispensing. The receiving table 49 can catch the glue left from the dispensing head 48 when not dispensing.

An air outlet pipe 40 is connected to the air outlet of the air pump 38, and the air outlet pipe 40 is in communication with the storage cavity 41. When the air pump 38 is activated, the air pump 38 inflates and pressurizes the storage cavity 41.

A communication inlet 43 is provided between the top wall of the storage chamber 41 and the top surface of the storage box 42. A scale 44 is provided on the right side of the storage box 42. A bottom wall of the storage chamber 41 is provided. A glue pipe 45 is provided, the glue pipe 45 passes through the support post 39, the dispensing head 48 communicates with a fixed installation joint 47, the joint 47 communicates with the support post 39, and the glue pipe 45 is fixed inside The control valve 46 is installed. When the pressure in the storage chamber 41 increases, the glue in the storage chamber 41 is sprayed out through the rubber outlet pipe 45 and the joint 47 with a glue head 48.

The clamping mechanism 81 further includes a vibration motor 13 fixedly installed in the base 10. A first bevel gear 15 is fixed on the output shaft of the vibration motor 13, and a second bevel gear 27 is fixed on the eccentric shaft 19. The second bevel gear 27 meshes with the first bevel gear 15, and the vibration motor 13 is started. The vibration motor 13 drives the first bevel gear 15 to rotate, and the first bevel gear 15 rotates to cause the second bevel gear 27 to rotate. Rotation of the bevel gear 27 drives the eccentric 20 to rotate.

The coil fixing seat 21 is slidably connected with the eccentric wheel 20, and a pulling spring 18 is fixedly installed between the bottom surface of the eccentric wheel 20 and the bottom wall of the eccentric wheel space 17. When the eccentric wheel 20 rotates, the coil fixing seat 21 can be made. It vibrates up and down, so that the gas in the glue in the coil is discharged.

The coil fixing base 21 is hingedly installed with a clamping plate 24, and the clamping plate 24 is hinged with a fixing rod 23. The coil fixing base 21 is fixed with a fixing buckle 22, and the fixing rod 23 and the fixing buckle 22 can be hooked to each other. If the coil is clamped, the rope 26 is fixedly connected between the coil clamping space 25 and the pull rope 26. The coil is placed in the coil clamping space 25, and the clamp plate 24 can clamp the coil.

A gear is provided on an inner wall of the rotation space 14, and a rotation motor 11 is fixedly installed in the base 10. A third gear 12 is fixedly installed on an output shaft of the rotation motor 11, and the third gear 12 and the rotation space 14 are fixedly installed. The gears on the inner wall mesh. When the rotating motor 11 is started, the rotating motor 11 drives the third gear 12 to rotate, and the third gear 12 rotates to rotate the rotating platform 16 so that the coils that need to be dispensed can be switched.

The coil is placed in the coil clamping space 25. The clamp plate 24 can clamp the coil, start the rotation motor 11, the rotation motor 11 drives the third gear 12 to rotate, and the third gear 12 rotates to drive the rotation platform 16 to rotate. The coil can be switched. After starting the air pump 38, the air pump 38 inflates and pressurizes the storage chamber 41. When the coil rotates to the lower side of the dispensing station, the lifting motor 35 is started, and the lifting motor 35 drives the first gear 34 to rotate. A gear 34 rotates to drive the second gear 36, and the second gear 36 drives the threaded rod 37 to slide downward. The threaded rod 37 drives the connecting rod 31 and the inclined block 30 to slide downward, so that the fixed pin 51 drives the torsion spring 50 and the receiving platform. 49 rotates backward, the receiving table 49 will not block the dispensing head 48 after rotating backward, it is convenient to dispense, you can align the coil downward, control the opening of the control valve 46, and the glue in the storage cavity 41 passes the glue pipe 45 And the joint 47 is a bit of glue head 48 ejected for dispensing,

The receiving table 49 can catch the glue left from the dispensing head 48 when not dispensing.

After the dispensing is completed, the vibration motor 13 is started. The vibration motor 13 drives the first bevel gear 15 to rotate. The first bevel gear 15 rotates to drive the second bevel gear 27 to rotate. The second bevel gear 27 rotates to drive the eccentric wheel 20 to rotate. The coil fixing base 21 can be shaken up and down, so that the gas in the glue in the coil can be discharged.

The beneficial effects of the present invention are: the method for improving the dispensing of the present invention does not require manual dispensing, increases the efficiency of dispensing, can also significantly reduce air bubbles generated after dispensing, and improves the quality of the coil,

The glue is squeezed out by means of pressure. When the glue is in the storage chamber, the pressure of the glue should increase. The bubbles in the glue will be precipitated. After the dispensing is completed, use the vibration method to shake the bubbles in the coil. Come out, so that the coil has better quality and is worth promoting.

Those skilled in the art can clearly understand that various modifications to the above embodiments can be made without departing from the overall spirit and concept of the present invention. They all fall within the protection scope of the present invention. The protection scheme of the present invention is subject to the claims attached to the present invention.

1. An electromagnetic coil dispensing machine for improving waterproof performance, comprising a base, characterized in that: a support post is fixedly installed on the top surface of the base, and the support post is provided with a glue outlet capable of dispensing the coil. Mechanism, the glue dispensing mechanism includes a cantilever fixedly installed on the left side of the support column, a threaded rod is slidably installed on the cantilever, and a dispensing head that can be used to dispense coils is fixedly installed at the bottom of the threaded rod A storage box is fixedly installed on the right side of the support column, and a storage cavity is provided in the storage box. The storage cavity is filled with glue for dispensing. An air pump is fixedly installed on the top surface of the support column. Inflate and pressurize the storage cavity to make the glue in the storage cavity squeeze out through the dispensing head,
a rotation platform is rotatably installed on the top surface of the base, and the rotation platform is provided with a clamping mechanism capable of clamping a coil. The clamping mechanism includes a rotation space provided on the top surface of the rotation platform. An eccentric wheel space with an upward opening is provided on the rotating platform. An eccentric wheel shaft is rotatably installed between the eccentric wheel space and an inner wall on one side of the rotating space. The eccentric wheel shaft is fixedly mounted with the eccentric wheel. The coil fixing seat is provided with a coil clamping space capable of clamping the coil. When the eccentric rotates, the coil fixing seat will be driven to vibrate up and down, so that the glue on the coil in the coil clamping space is contained in the coil. The bubbles can be removed.

2. The electromagnetic coil dispensing machine for improving waterproof performance according to claim 1, wherein the glue dispensing mechanism further comprises a gear cavity provided in the cantilever, and a bottom wall of the gear cavity A lifting motor is fixedly installed internally, a first gear is fixedly mounted on an output shaft of the lifting motor, a second gear is rotatably installed between the upper and lower inner walls of the gear cavity, and the second gear is threadedly installed with the threaded rod.

3. 3. The electromagnetic coil dispensing machine for improving waterproof performance according to claim 1, characterized in that: a connecting base is fixedly installed on the bottom surface of the cantilever, and a rotary table is rotatably installed on the connecting base, and the rotary table and A torsion spring is provided between the connection bases, a receiving platform is fixedly installed on the right side of the turntable, a fixing pin is fixedly installed on the rear side of the torsion spring, and a connection rod is fixedly installed on the threaded rod. An inclined block is fixedly installed on the connecting rod, and the inclined block is slidably installed with the fixing pin.

4. The electromagnetic coil dispenser for improving waterproof performance according to claim 1, characterized in that an air outlet pipe is connected to the air outlet of the air pump, and the air outlet pipe is in communication with the storage cavity.

5. The electromagnetic coil dispenser for improving waterproof performance according to claim 1, wherein a communication inlet is provided between a top wall of the storage cavity and a top surface of the storage box, and A scale is provided on the right side of the storage box, and a rubber outlet tube is provided on the bottom wall of the storage cavity. The rubber outlet tube runs through the support column. The dispensing head communicates with a fixed installation joint. The support pillars communicate with each other, and a control valve is fixedly installed in the rubber pipe.

6. The electromagnetic coil dispenser for improving waterproof performance according to claim 1, wherein the clamping mechanism further comprises a vibration motor fixedly installed in the base, and the vibration motor output A first bevel gear is fixedly mounted on the shaft, a second bevel gear is fixedly mounted on the eccentric shaft, and the second bevel gear meshes with the first bevel gear.

7. The electromagnetic coil dispenser for improving the waterproof performance according to claim 1, wherein the coil fixing seat is slidably connected with an eccentric wheel, and the bottom surface of the eccentric wheel and the eccentric wheel space A pull spring is fixedly installed between the bottom walls.

8. The electromagnetic coil dispenser for improving waterproof performance according to claim 1, characterized in that: the coil fixing base is hingedly installed with a clamping plate, the clamping plate is hingedly installed with a fixing rod, and the coil is fixed A fixing buckle is fixedly installed on the seat, and the fixing rod and the fixing buckle can be hooked to each other to clamp a coil, and a pulling rope is fixedly connected between the coil clamping space and the pulling rope.

9. 9. The electromagnetic coil dispenser for improving waterproof performance according to claim 1, wherein a gear is provided on an inner wall of the rotation space, and a rotation motor is fixedly installed in the base, and the rotation A third gear is fixedly installed on the motor output shaft, and the third gear meshes with the gear on the inner wall of the rotation space. When the rotation motor is started, the rotation motor drives the third gear to rotate, and the third gear rotation drives the rotation platform to rotate, Coils that require dispensing can be switched.
